(19) United States
(12) Patent Application Publication
(10) Pub. No.: US 2024/0018967 A1
(43) Pub. Date: Jan. 18, 2024

(54) SHAFTLESS ELECTRIC FLUID-FLOW DEVICE

(71) Applicant: Gregory M. Waugh, Roseburg, OR (US)

(72) Inventor: Gregory M. Waugh, Roseburg, OR (US)

(21) Appl. No.: 17/867,546

(22) Filed: Jul. 18, 2022

(51) Int. Cl. F04D 25/06; B64C 29/00; B64D 27/24; F04D 19/00; F04D 29/52

(52) U.S. Cl. CPC F04D 25/0633; B64C 29/0033; B64D 27/24; F04D 19/002; F04D 25/062; F04D 29/522

(57) ABSTRACT

An aircraft that includes a fuselage and wings fixed to the fuselage. The aircraft further includes a shaftless electric fluid-flow device that is coupled to the at least one of the fuselage or a corresponding one of the wings. The shaftless electric fluid-flow device includes a housing and a shaftless hub, which is rotatable within the housing, about a central axis, and defines an open central channel that is open along the central axis. The shaftless electric fluid-flow device also includes a fan blade assembly that is coupled to the shaftless hub, such that the fan blade assembly co-rotates with the shaftless hub. The fan blade assembly includes a plurality of fan blades.

### FIELD

This disclosure relates generally to electric motors, and more particularly to a shaftless electric fluid-flow device for efficient movement of fluid therethrough.

### BACKGROUND

The most common type of electric motors are brushed electric motors and brushless electric motors. Brushed electric motors typically require more parts for operation of the motors than do brushless electric motors, which can reduce reliability and efficiency compared to brushless electric motors.

Brushless motors have either an inrunner configuration or an outrunner configuration. Inrunner configurations include a rotor that is attached to permanent magnets, which spin relative to a stationary casing. Outrunner configurations include a rotor that is attached to the case, which spins relative to stationary permanent magnets.

In either an inrunner configuration or an outrunner configuration, the rotor includes a central shaft about which the rotor rotates. For an electric motor operable to drive a fluid, such as air, through a central channel of the electric motor, the central shaft of the rotor is located centrally within the central channel. Because of the central shaft, the volume of fluid that can be driven through the central channel is limited.

### SUMMARY

The subject matter of the present application has been developed in response to the present state of the art, and in particular, in response to the shortcomings of electric motors, that have not yet been fully solved by currently available techniques. Accordingly, the subject matter of the present application has been developed to provide a shaftless electric fluid-flow device, having a shaftless hub and an open central channel, which overcomes at least some of the above-discussed shortcomings of prior art techniques.

The following is a non-exhaustive list of examples, which may or may not be claimed, of the subject matter, disclosed herein.

Disclosed herein is aircraft that comprises a fuselage. The aircraft also comprises wings fixed to the fuselage. The aircraft further comprises a shaftless electric fluid-flow device that is coupled to the at least one of the fuselage or a corresponding one of the wings. The shaftless electric fluid-flow device comprises a housing and a shaftless hub, which is rotatable within the housing, about a central axis, and defines an open central channel that is open along the central axis. The shaftless electric fluid-flow device additionally comprises a fan blade assembly that is coupled to the shaftless hub, such that the fan blade assembly co-rotates with the shaftless hub, and comprises a plurality of fan blades. The preceding subject matter of this paragraph characterizes example 1 of the present disclosure.

The aircraft further comprises a plurality of shaftless electric fluid-flow devices coupled to the at least one of the fuselage or the corresponding one of the wings. The preceding subject matter of this paragraph characterizes example 2 of the present disclosure, wherein example 2 also includes the subject matter according to example 1, above.

The shaftless electric fluid-flow device is pivotable, relative to the at least one of the fuselage or the corresponding one of the wings. The preceding subject matter of this paragraph characterizes example 3 of the present disclosure, wherein example 3 also includes the subject matter according to any of examples 1-2, above.

The open central channel extends along the central axis from a first end of the open central channel to a second end of the open central channel. The fan blade assembly is fixed to the first end of the open central channel. The shaftless electric fluid-flow device further comprises a second fan blade assembly that is fixed to the second end of the open central channel, such that the second fan blade assembly co-rotates with the shaftless hub, and that comprises a plurality of fan blades. The preceding subject matter of this paragraph characterizes example 4 of the present disclosure, wherein example 4 also includes the subject matter according to any of examples 1-3, above.

Further disclosed herein is a shaftless electric fluid-flow device comprising a housing and a shaftless hub. The shaftless hub is rotatable within the housing, about a central axis, and defines an open central channel that is open along the central axis. The shaftless electric fluid-flow device further comprises a fan blade assembly that is coupled to the shaftless hub, such that the fan blade assembly co-rotates with the shaftless hub, and that comprises a plurality of fan blades. The preceding subject matter of this paragraph characterizes example 5 of the present disclosure.

The open central channel extends along the central axis from a first end of the open central channel to a second end of the open central channel. The fan blade assembly is fixed to the first end of the open central channel. The shaftless electric fluid-flow device further includes a second fan blade assembly, fixed to the second end of the open central channel, such that the second fan blade assembly co-rotates with the shaftless hub, and comprising a plurality of fan blades. The preceding subject matter of this paragraph characterizes example 6 of the present disclosure, wherein example 6 also includes the subject matter according to example 5, above.

The fan blade assembly and the second fan blade assembly are located within the open central channel. The preceding subject matter of this paragraph characterizes example 7 of the present disclosure, wherein example 7 also includes the subject matter according to any of examples 5-6, above.

The outer edges of the fan blade assembly and the second fan blade assembly are enclosed within the shaftless hub. The preceding subject matter of this paragraph characterizes example 8 of the present disclosure, wherein example 8 also includes the subject matter according to any of examples 5-7, above.

When rotated in a first rotational direction about the central axis, the plurality of fan blades of the fan blade assembly and the second fan blade assembly drive a fluid, outside the housing, through the central axis and the open central channel in a first direction. When rotated in a second rotational direction, opposite the first rotational direction, about the central axis, the plurality of fan blades of the fan blade assembly and the second fan blade assembly drive the fluid, outside the housing, through the central axis and the open central channel in a second direction, opposite the first direction. The preceding subject matter of this paragraph characterizes example 9 of the present disclosure, wherein example 9 also includes the subject matter according to any of examples 5-8, above.

The motor core housing comprises an inner case disposed between the motor cap and the second motor cap, a plurality of magnets, disposed around the inner case near the first motor end cap, and a magnet position sensor disposed between the first motor end cap and the plurality of permanent magnets. The preceding subject matter of this paragraph characterizes example 10 of the present disclosure, wherein example 10 also includes the subject matter according to any of examples 5-9, above.

The plurality of magnets are configured to rotate around the inner case of the shaftless electric fluid-flow device such that the fan blade assembly and second fan blade assembly are rotated relative to the inner lamination stack. The preceding subject matter of this paragraph characterizes example 11 of the present disclosure, wherein example 11 also includes the subject matter according to example 10, above.

The magnet position sensor is configured to monitor the position of the permanent magnets. The preceding subject matter of this paragraph characterizes example 12 of the present disclosure, wherein example 12 also includes the subject matter according to any of examples 10-11, above.

The shaftless electric fluid-flow device further comprises a lamination stack assembly that is disposed between the fan blade assembly and the second fan blade assembly. The lamination stack assembly is further disposed around the plurality of permanent magnets. The shaftless electric fluid-flow device further comprises a housing that is fixedly connected to the motor cap and the second motor cap, and is disposed around the lamination stack assembly. The preceding subject matter of this paragraph characterizes example 13 of the present disclosure, wherein example 13 also includes the subject matter according to any of examples 5-12, above.

The lamination stack assembly comprises a plurality of wire coils, configured to provide a magnetic field for the shaftless electric fluid-flow device, an outer lamination stack, disposed around the plurality of wire coils and configured to reduce eddy current losses of the shaftless electric fluid-flow device, and an inner lamination stack, disposed on the inner radius of the plurality of wire coils and configured to reduce eddy current losses of the shaftless electric fluid-flow device. The preceding subject matter of this paragraph characterizes example 14 of the present disclosure, wherein example 14 also includes the subject matter according to example 13, above.

The shaftless electric fluid-flow device further comprises a bearing and a second bearing, which are configured to reduce friction between the first end of the shaftless hub and the motor cap and the second end of the shaftless hub and the second motor cap when the shaftless hub is rotating. The preceding subject matter of this paragraph characterizes example 15 of the present disclosure, wherein example 15 also includes the subject matter according to any of examples 5-14, above.

When rotating, the fan blade assembly pushes or pulls fluid through the central axis of the open central channel. The preceding subject matter of this paragraph characterizes example 16 of the present disclosure, wherein example 16 also includes the subject matter according to any of examples 5-15, above.

The open central channel is free from obstruction along the central axis of the open central channel. The preceding subject matter of this paragraph characterizes example 17 of the present disclosure, wherein example 17 also includes the subject matter according to any of examples 5-16, above.

Additionally disclosed herein is a method of moving fluid through an open central channel. The method comprises a step of selecting a direction of fluid flow through the open central channel. The method also comprises rotating blades about an axis of rotation of a fan blade assembly or a second fan blade assembly at opposite ends of an unoccupied open channel such that a fluid flows unobstructed through the open central channel and the central channel is coaxial with the axis of rotation of the blades. The preceding subject matter of this paragraph characterizes example 18 of the present disclosure.

Rotation of the blades is driven by electrical power from a power source and rotating the blades of the fan blade assembly and the second fan blade assembly pushes fluid though an open central channel. The preceding subject matter of this paragraph characterizes example 19 of the present disclosure, wherein example 19 also includes the subject matter according to example 18, above.

The method further comprises a step of positioning the shaftless electric fluid-flow device into a fluid stream. The step of rotating the blades about the axis of rotation comprises directing the fluid stream over the fan blade assembly, through the shaftless hub, and over the second fan blade assembly such that the fluid stream drives rotation of the fan blade assembly and the second fan blade assembly. The method additionally comprises a step of generating electricity via rotation of the blades about the axis of rotation and a step of storing the electricity in a battery. The preceding subject matter of this paragraph characterizes example 20 of the present disclosure, wherein example 20 also includes the subject matter according to 18, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic, perspective view of an aircraft, according to one or more examples of the present disclosure;

FIG. 2 is a schematic, perspective view of a shaftless electric fluid-flow device, according to one or more examples of the present disclosure;

FIG. 3 is a schematic, perspective view of a section view of a shaftless electric fluid-flow device, according to one or more examples of the present disclosure;

FIG. 4 is a schematic, front view of a section of a shaftless electric fluid-flow device, according to one or more examples of the present disclosure;

FIG. 5 is a schematic, perspective view of a section of a shaftless electric fluid-flow device, according to one or more examples of the present disclosure;

FIG. 6, is a schematic, perspective view of a section of a shaftless electric fluid-flow device, according to one or more examples of the present disclosure;

FIG. 7 is a schematic, perspective view of a lamination stack assembly of a shaftless electric fluid-flow device, according to one or more examples of the present disclosure;

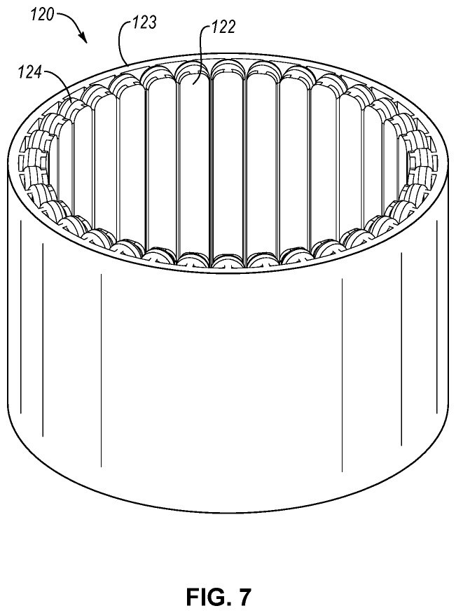

FIG. 8 is a schematic, top view of a shaftless hub of a shaftless electric fluid-flow device, according to one or more examples of the present disclosure;

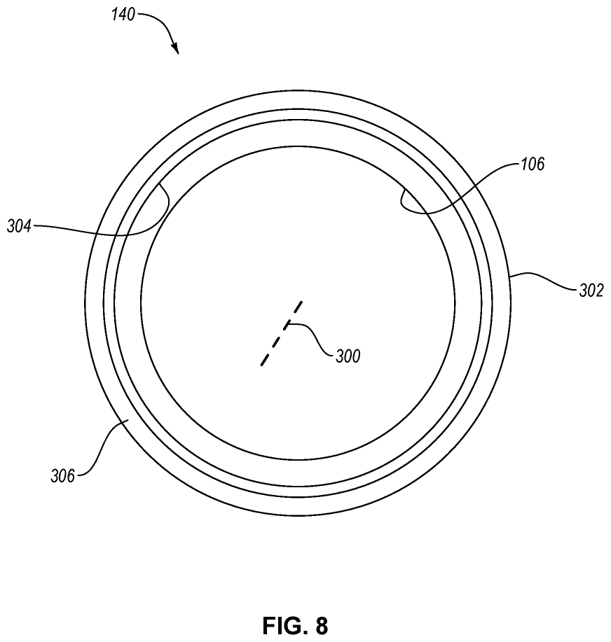

FIG. 9 is a schematic, perspective view of a shaftless hub of a shaftless electric fluid-flow device, according to one or more examples of the present disclosure;

FIG. 10 is a schematic flow chart of a method of moving fluid through an electric fluid-flow device, according to one or more examples of the present disclosure;

FIG. 11 is schematic, perspective view of a fan blade assembly, according to one or more examples of the present disclosure; and

FIG. 12 is a schematic, side view of a shaftless electric fluid-flow device, configured as a generator, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Electric motors are used in various applications, such as for producing lift for an aircraft. Generally, electric motors, such as brushless electric motors, convert electrical energy into mechanical energy in the form of mechanical rotation. When used to produce lift, the mechanical rotation enables rotation of fan blades, which, when orientated appropriately, drive air through a central channel of the electric motors. However, conventional electric motors used to produce lift have a central shaft extending through the middle of the central channel and about which the fan blades rotate. The central shaft obstructs the flow of fluid through the central channel, which reduces the lift-generating capacity and efficiency of the electric motor.

In the present disclosure, in some examples, the shaftless electric fluid-flow device is used to generate lift, which includes both vertical and horizontal propulsion. Unlike conventional electric motors used to generate lift, the shaftless electric fluid-flow device disclosed herein does not have a central shaft at the center of the central channel of the shaftless electric fluid-flow device. More specifically, the shaftless electric fluid-flow device includes a shaftless hub that defines the central channel. Because the shaftless electric fluid-flow device is shaftless, the central channel provide unobstructed flow of a fluid, e.g., air, water, etc., through the central channel without being obstructed by a central shaft, which promotes efficiency of the shaftless electric fluid-flow device. Additionally, without a central shaft, there is extra space to facilitate a larger volumetric flow of fluid through the central channel, which improves the overall capacity of the shaftless electric fluid-flow device.

Not having a central shaft, extending through the central channel of the shaftless electric fluid-flow device, has additional advantages. For example, the absence of a central shaft permits the motor to have a relatively smaller size, compared to motors with central shafts. The absence of a central shaft also permits the shaftless electric fluid-flow device to weigh less than comparable conventional motors.

In the context of an aircraft, as defined herein, lift can mean propulsion in any of various directions, including vertically and horizontally. Accordingly, as used herein, lift is not limited to forces that lift an aircraft in a vertical direction, but also includes forces that propel an aircraft in a non-vertical direction. The fluid can also be water, or other liquid. In such cases, where the electric lift motor is attached to a watercraft or submersible vehicle, lift generated by the electric lift motor is in the form of horizontal and/or vertical propulsion of the vehicle through or over liquid.

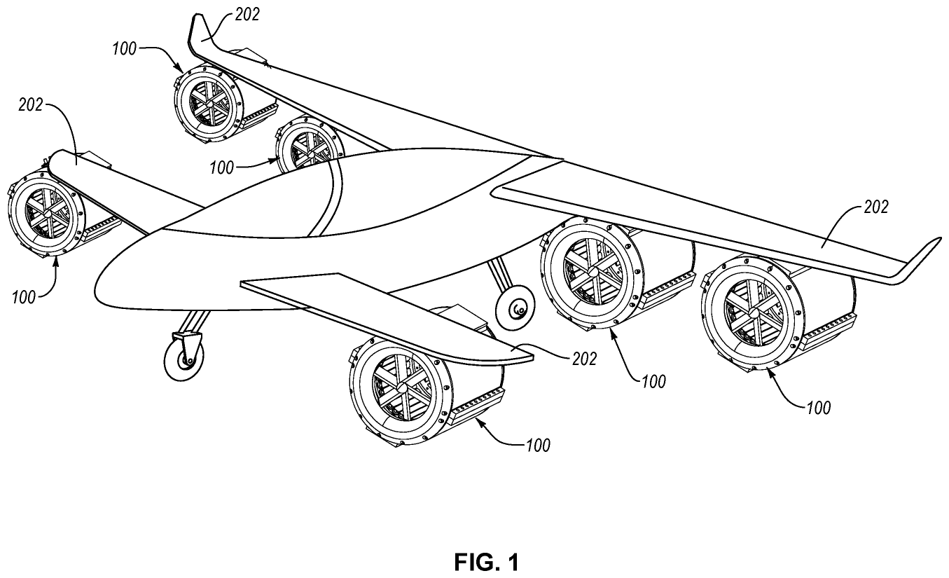

Referring to FIG. 1, according to some examples, an aircraft 200 includes at least one shaftless electric fluid-flow device 100. Additionally, the aircraft 200 includes a plurality of wings 202 and a fuselage 201. In the illustrated example, as shown, the plurality of shaftless electric fluid-flow devices 100 are attached to the plurality of wings 202. Although not shown, in some examples, one or more of the plurality of shaftless electric fluid-flow devices 100 is attached to the fuselage 201. In some examples, the shaftless electric fluid-flow devices 100 are pivotable relative to at least one of the fuselages 202 or the plurality of wings 202. Generally, each one of the shaftless electric fluid-flow devices 100 is operable to drive air in at least one direction to generate lift, for lifting the aircraft 200 and/or to generate thrust, for propelling the aircraft 200. The aircraft 200 can have any number of shaftless electric fluid-flow devices 100, which can be located at any of various locations on the aircraft 200. According to some examples, the aircraft 200 is a personal aerial vehicle, which can transport one or more passengers. In other examples, the aircraft 100 is an unmanned aerial vehicle.

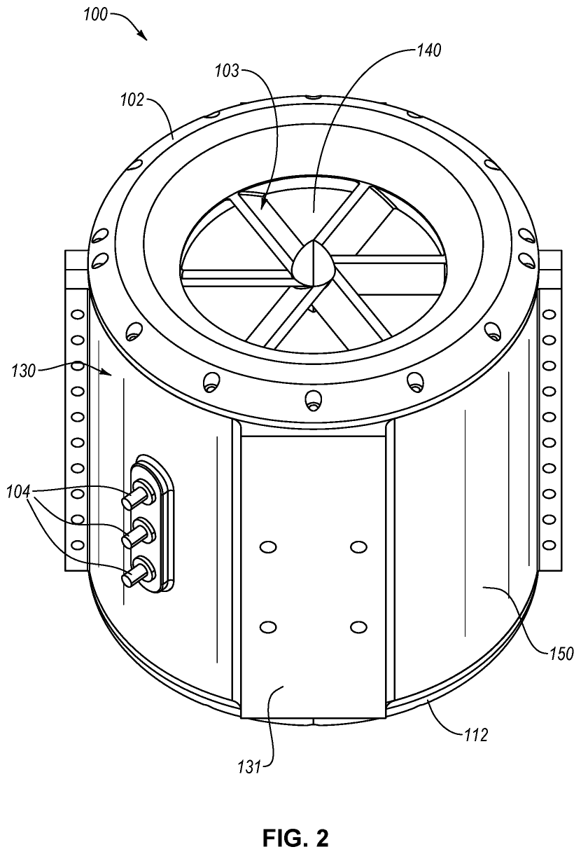

Referring to FIG. 2, according to certain examples, the shaftless electric fluid-flow device 100 includes a housing 130, a shaftless hub 140, and a fan blade assembly 103. Generally, the housing 130 is configured to protect and secure internal components of the shaftless electric fluid-flow device 100. Accordingly, in some examples, the housing 130 is a substantially hollow cylindrical structure within which the internal components, as defined below, are housed. In some examples, the housing 130 has an exterior mounting surface 131, which is configured to facilitate mounting of the shaftless electric fluid-flow device 100 to one of the wings 202 or to the fuselage 201. The exterior mounting surface 131 is flat in some examples, but in other examples is contoured to complement the contour of the wings 202 or the fuselage 201. The housing 130 includes a cylindrical wall portion 150 that has two open ends, which are opposite each other. The housing 130 additionally includes a pair of motor caps, such as motor cap 102 and second motor cap 112, each fixed to a corresponding one of the two open ends of the cylindrical wall portion 150 of the housing 130. The motor cap 102 and the second motor cap 112 are ring-shaped, such that when fixed to the cylindrical wall portion 150, they do not obstruct flow through the shaftless electric fluid-flow device 100.

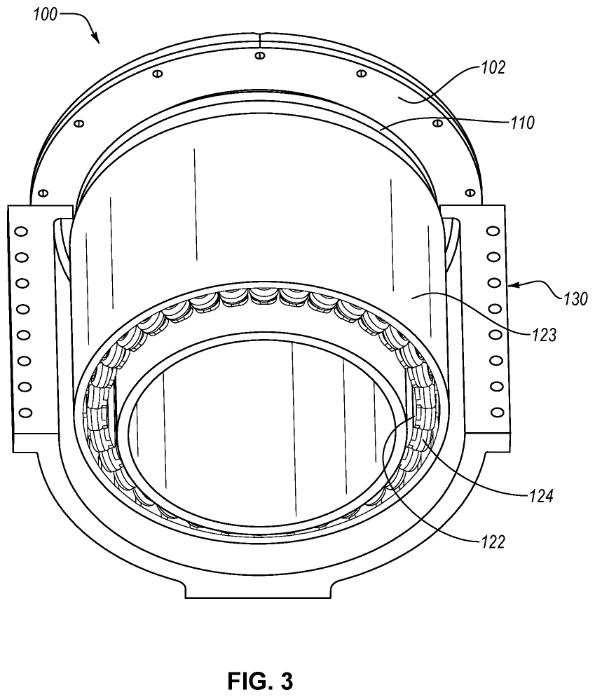

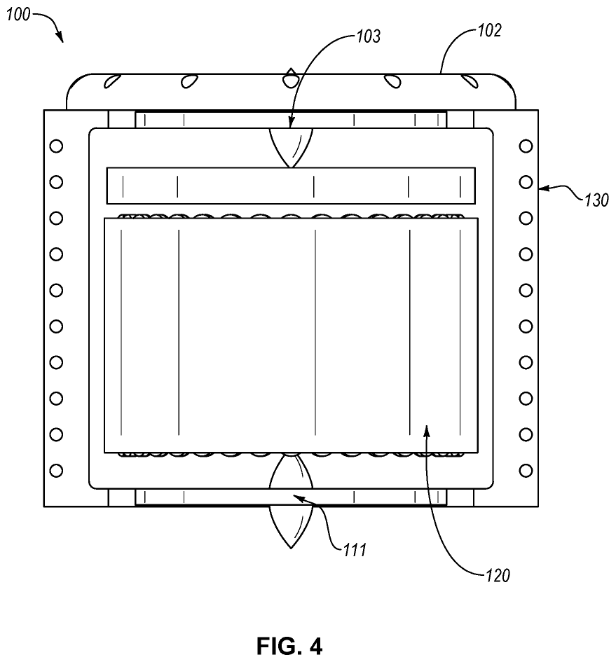

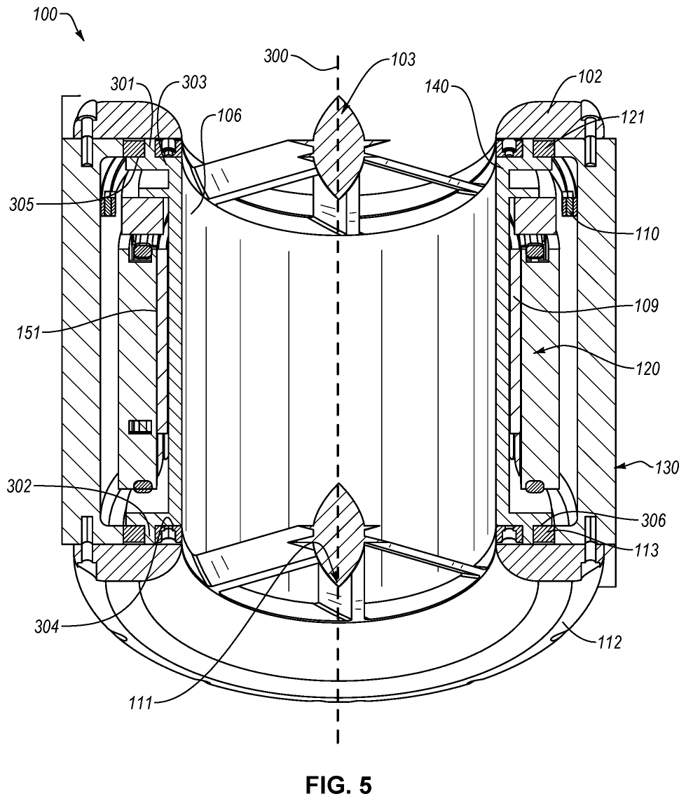

Referring to FIGS. 3-5, according to certain examples, the shaftless electric fluid-flow device 100 comprises a magnet position sensor 110, a lamination stack 120, a fan blade assembly 103, and a second fan blade assembly 111. The fan blade assembly 103 is disposed within an upper portion of the housing 130, and retained within the housing 130, at least partially, by the motor cap 102. More specifically, the fan blade assembly 103 is disposed in a first end 301 of the shaftless hub 140 (see, e.g., FIG. 5), such that the fan blade assembly 103 is nested in an inner recess 303 of the first end 301 of the shaftless hub 140. Similarly, the second fan blade assembly 111 is disposed in a lower portion of the housing 130, and retained in the housing 130, at least partially, by the second motor cap 112. More specifically, the second fan blade assembly 111 is disposed in a second end 302 of the shaftless hub 140, such that the second fan blade assembly 111 is nested in an inner recess 304 of the second end 302 of the shaftless hub 140. In some examples, the second end 302 of the shaftless hub 140 is configured the same as the first end 301 of the shaftless hub 140.

The fan blade assembly 103 and the second fan blade assembly 111 are co-movably fixed to the upper and lower portions of the shaftless hub 140, respectively, as shown in FIG. 5. Accordingly, the fan blade assembly 103 and the second fan blade assembly 111 co-rotate with the shaftless hub 140. In other words, as the shaftless hub 140 rotates, so do the fan blade assembly 103 and the second fan blade assembly 111.

A central axis 300 of the shaftless hub 140 also defines a central axis of the shaftless electric fluid-flow device 100. Moreover, the shaftless hub 140, the fan blade assembly 103, and the second fan blade assembly 111 rotate about the central axis 300. The shaftless hub 140 is hollow or open, such that no obstruction to flow is present within the open central channel 106 between the fan blade assembly 103 and the second fan blade assembly 111. Accordingly, there is no shaft, or other component, extending axially along the central axis 300. In other words, the central channel 106 is open and unobstructed along and through the central axis 300 of the shaftless hub 140. The open central channel 106 is disposed between the fan blade assembly 103 and the second fan blade assembly 111. The open central channel 106 allows for air (or other fluid) to flow through the shaftless electric fluid-flow device 100 in the direction that the fan blade assembly 103 and the second fan blade assembly 111 drive (e.g., push/pull) it, which is dictated by the co-rotational direction of the fan blade assembly 103 and the second fan blade assembly 111.

Referring to the shaftless electric fluid-flow device 100, the open central channel 106 extends along the central axis 300 from a first end 301 of the open central channel 106 to a second end 302 of the open central channel 106. The fan blade assembly 103 and the second fan blade assembly 111, being fixed to the first end 301 and second end 302 of the open central channel 106, co-rotate with the shaftless hub 140. The fan blade assembly 103 and the second fan blade assembly 111 are located within the open central channel 106.

The outer edges of the fan blade assembly 103 and the second fan blade assembly 111 are enclosed by bearings 121, motor caps 102, and the shaftless hub 140 such that when rotated in a first direction about the central axis 300, the plurality of fan blades of the fan blade assembly 102 and the second fan blade assembly 111 drive a fluid through the central axis 300 and the open central channel 106 in a first direction. When rotated in a second rotational direction, opposite the first rotational direction, about the central axis 300, the plurality of fan blades of the fan blade assembly 103 and the second fan blade assembly 111 drive the fluid outside the housing 130, through the central axis 300 and the open central channel 106 in a second direction, opposite the first direction.

The magnet position sensor 110 is configured to monitor the position of the permanent magnets 109 and is configured to generate a signal, comprising position data, that is sent to a controller for processing. In some examples, the magnet position sensor 110 is disposed within the upper portion of the housing 130 near the motor cap 102. The magnet position sensor 110 is fixed to the housing 130, in certain examples.

The plurality of magnets 109 are configured to co-rotate with the shaftless hub 140 inside the inner lamination stack 122. The inner lamination stack 122 and the outer lamination stack 123 are disposed around the plurality of wire coils 124 such that eddy current losses are reduced. The plurality of wire coils 124 are configured to provide a magnetic field for the shaftless electric fluid-flow device 100.

The open central channel 106, being unoccupied, enables the shaftless electric fluid-flow device 100 to be scalable in size. Moreover, the absence of a shaft in the open central channel 106 promotes an increase in flow efficiency of fluid through the open central channel 106 and along the central axis 300.

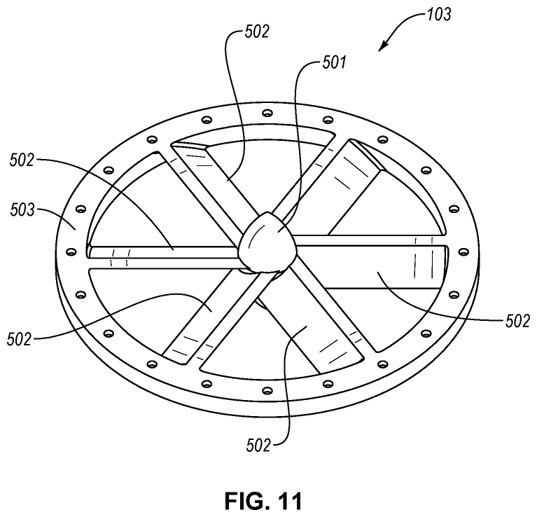

Each one of the fan blade assembly 103 and the second fan blade assembly 111 comprises a center hub element 501, a plurality of blades 502, and an outer ring 503, as shown in FIG. 11. The center hub element 501 is concentric (e.g., in-line) with the central axis 300 of the shaftless hub 140. For each one of the fan blade assembly 103 and the second fan blade assembly 111, the plurality of blades 502 extend radially from the corresponding center hub element 501 to the corresponding outer ring 503. The plurality of blades 502 are angled such that fluid is either pulled into the open central channel 106 or pushed out of the open central channel 106, depending on the direction of rotation. The plurality of blades 502 of the fan blade assembly 103 and the second fan blade assembly 111 are angled in such a way that air flows into and out of the open central channel 106 in either one of two opposite directions, depending on which of two opposite rotational directions the fan blade assemblies are rotating.

In alternative examples, the fan blade assembly 103 and the fan blade assembly comprise a plurality of blades 502 having at least one blade. The fan blade assembly can be produced with current fabrication processes and printing fabrication processes, similar to the processes of turbine engines. The plurality of blades 502 can be shaped for creating pressures and flows based on the fluid that passes through the shaftless hub 140.

The shaftless hub 140 is rotatable within the housing 130. Moreover, rotation of the shaftless hub 140, relative to the housing 130, is facilitated by a bearing 121 and a second bearing 113. The bearing 121 is disposed between the housing 130, the motor cap 102, and the shaftless hub 140. More specifically, the bearing 121 is disposed in the first end 301 of the shaftless hub 140, such that the bearing 121 is nested in the outer recess 305 of the first end 301 of the shaftless hub 140. Similarly, the second bearing 113 is disposed between the housing 130, the second motor cap 112, and the shaftless hub 140. More specifically, the second bearing 113 is disposed in the second end 302 of the shaftless hub 140, such that the plurality of second bearings 113 are nested in the outer recess 306 of the second end 302 of the shaftless hub 140. The bearing 121 and the second bearing 113 enable co-rotation of the shaftless hub 140 and the fan blade assembly 103, relative to the housing 130, by facilitating a low friction interface between the housing 130 and the shaftless hub 140. In one example, each one of the bearing 121 and the second bearing 113 includes an inner ring fixed to the shaftless hub 140, an outer ring fixed to the housing 130, and balls (e.g., rolling elements) between the inner ring and the outer ring, and configured to rotate along tracks formed in the inner and outer ring as the inner and outer ring rotate relative to each other. In one example, the bearing 121 is configured such that the fluid flow can be incorporated into the bearing assembly for lubrication and physical separation. The bearing 121 may be spherical, cylindrical, or tapered.

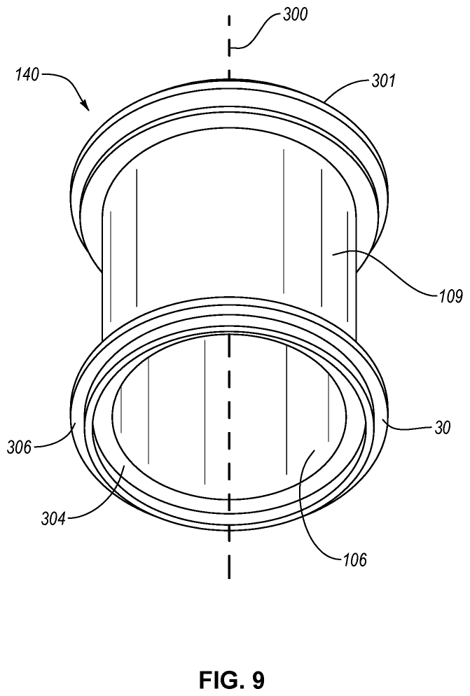

According to FIG. 9, the permanent magnets 109 are disposed around the outside of the shaftless hub 140. The permanent magnets 109 are fixed to the shaftless hub 140, such that the permanent magnets 109 and the shaftless hub 140 co-rotate. In some examples, the permanent magnets 109 are arranged cylindrically around the shaftless hub 140 in an alternating sequence of north and south poles.

The lamination stack assembly 120 is disposed near the middle of the housing 130, between the two open ends of the cylindrical wall portion 150 of the housing 130. For example, the lamination stack assembly 120 is positioned within a space defined between the permanent magnets 109 and cylindrical wall portion 150 of housing 130. The lamination stack assembly 120 comprises an inner lamination stack 122, an outer lamination stack 123, and a plurality of wire coils 124. The inner lamination stack 122 is disposed around the permanent magnets 109, such that the permanent magnets 109 are disposed between the inner lamination stack 122 and the shaftless hub 140. Moreover, a small gap 151 of clearance is defined between the inner lamination stack 122 and the permanent magnets 109 to allow for rotation of the permanent magnets 109 relative to the inner lamination stack 122.

The wire coils 124, as shown in FIG. 3, are disposed between the inner lamination stack 122 and the outer lamination stack 123. The wire coils 124 extend a length of the lamination stack assembly 120 and terminate at the ends of the lamination stack assembly 120. The lamination stack assembly 120 is fixed to the housing 130, such that the rotation of the shaftless hub 140 generates current in the wire coils 124. More specifically, in some examples, the outer lamination stack 123 is attached directly to the inside of the housing 130.

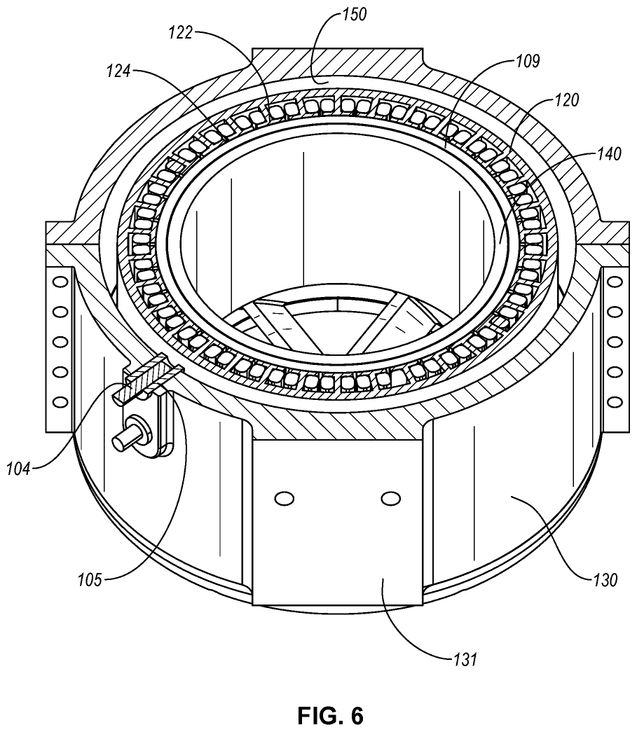

Referring to FIG. 6, each one of the wire coils 124 is electrically isolated from the others of the wire coils 124 along a length of the lamination stack 120. The electrical isolation helps reduce electromagnetic interference between the wire coils 124 as they are energized and de-energized.

The housing 130 further comprises electrical-power inlet ports 104, which, when coupled with an electrical power supply, supplies electrical power to the wire coils 124. The electrical-power inlet ports 104 include electrical conduits or wires within an electrical isolating sleeve 105, such that there is no interference between the electrical-power inlet ports 104. In some examples, the electrical-power inlet ports 104 are vertically aligned and/or near the exterior mounting surface 131.

The electrical power inlet ports 104 supply power, from a power source (not shown), to alternating ones of the wire coils 124. Alternating the power in this manner, transforms the alternating ones of the wire coils 124 into electromagnets. When energized, the alternating ones of the wire coils 124, functioning as electromagnets, causing the permanent magnet 109 and the shaftless hub 140 to rotate as the wires coils 124 are alternately energized. Rotation of the shaftless hub 140 causes the fan blade assembly 103 and the second fan blade assembly 111 to rotate, which rotates the plurality of fan blades. The angle of the plurality of fan blades causes fluid to be pulled into and pushed out from the open central channel 106. The direction of flow through the open central channel 106 is determinant on the direction of rotation of the fan blade assembly 103 and the second fan blade assembly 111.

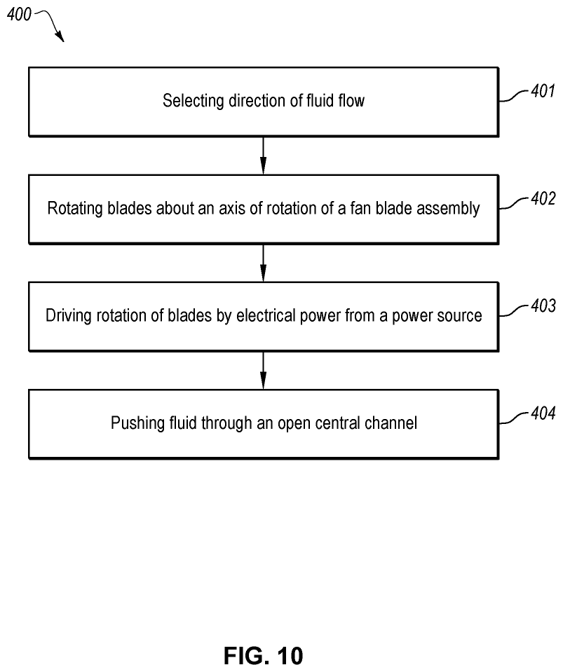

Referring to FIG. 10, one example of a method 400 of moving fluid through an open central channel 106 is shown. The method 400 includes (block 401) selecting a direction of fluid flow, (block 402) rotating blades of a fan blade assembly 103 and a second fan blade assembly 111, at opposite ends of an unoccupied open channel, such that a fluid flows unobstructed through the open central channel 106. In some examples, rotation of the blades includes (block 403) driving rotation of blades via electrical power from a power source, and (block 404) pushing fluid through the open central channel 106.

Although the shaftless electric fluid-flow device 100 has been described as providing lift or propulsion for a vehicle, in other examples, the shaftless electric fluid-flow device 100 can be configured for alternative uses. According to one example, the shaftless electric fluid-flow device 100 can function as an exhaust fan to move fluid from one location to another location via one or more pipes. For example, inlet and outlet pipes can be fluidically coupled with the shaftless electric fluid-flow device 100, which draws fluid from the inlet pipe and expels fluid into the outlet pipe. In alternative examples, the shaftless electric fluid-flow device 100 can function as a submersible transfer pump that, like the exhaust fan, moves fluid from one location to another. However, when functioning as a submersible transfer pump, the shaftless electric fluid-flow device 100 can have fluidic sealing components to protect the electrical components of the shaftless electric fluid-flow device 100 from contact with the fluid (e.g., a liquid). In either of these alternative configurations, the shaftless electric fluid-flow device 100 moves fluid by rotating the fan blade assembly 103 and the second fan blade assembly 111 to pull fluid into the open central channel 106, at an inlet end, and to push fluid out of the open central channel 106, at an outlet end.

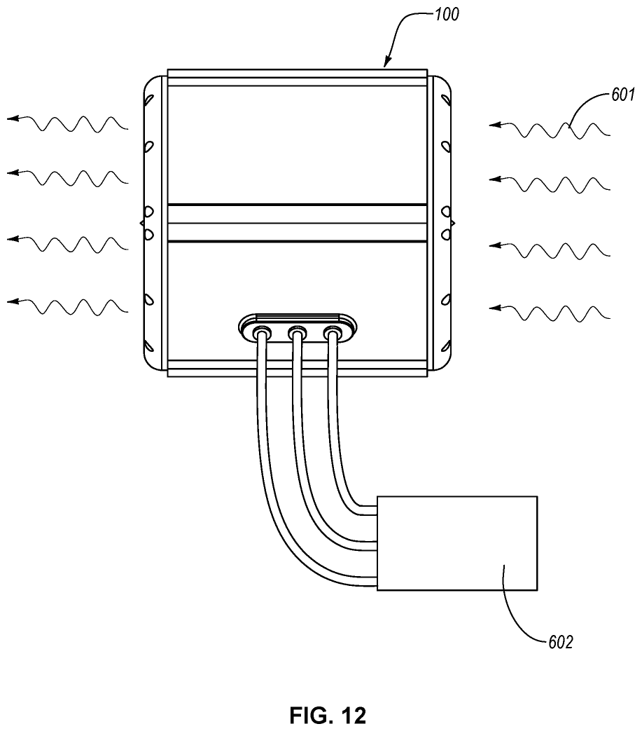

Referring to FIG. 12, according to another alternative use of the shaftless electric fluid-flow device 100, in some examples, the shaftless electric fluid-flow device 100 is configured to function as a generator. In such examples, the polarity of the wire coils 124 can be reversed and the shaftless electric fluid-flow device 100 can be electrically coupled with one or more batteries 602, instead of to a power source. When the electric fluid-flow device 100 is placed into a fluid stream 601, the fluid stream 601 passes over the fan blade assembly 103, enters the central open channel 106, and passes over the second fan blade assembly 111 before exiting the central open channel 106. The fluid stream 601, as it passes over the fan blade assembly 103 and the second fan blade assembly 111, engages the blades 502 of the fan blade assemblies, which urges the fan blade assembly 103 and the second fan blade assembly 111 to rotate. Rotation of fan blade assembly 103 and the second fan blade assembly 111 results in rotation of the shaftless hub 140. As the shaftless hub 140 rotates, electrical energy is generated, via the reversal of the polarity of the wire coils 124, and stored in the one or more batteries 602, or other power consuming device.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An aircraft comprising:
a fuselage;
wings fixed to the fuselage; and
a shaftless electric fluid-flow device, coupled to the at least one of the fuselage or a corresponding one of the wings, wherein the shaftless electric fluid-flow device comprises:
a housing;
a shaftless hub, rotatable within the housing, about a central axis, and defining an open central channel that is open along the central axis; and
a fan blade assembly, coupled to the shaftless hub, such that the fan blade assembly co-rotates with the shaftless hub, and comprising a plurality of fan blades.

2. The aircraft of claim 1, further comprising a plurality of shaftless electric fluid-flow devices coupled to the at least one of the fuselage or the corresponding one of the wings.

3. The aircraft of claim 1, wherein the shaftless electric fluid-flow device is pivotable, relative to the at least one of the fuselage or the corresponding one of the wings.

4. The aircraft of claim 1, wherein:
the open central channel extends along the central axis from a first end of the open central channel to a second end of the open central channel;
the fan blade assembly is fixed to the first end of the open central channel; and
the shaftless electric fluid-flow device further comprises a second fan blade assembly, fixed to the second end of the open central channel, such that the second fan blade assembly co-rotates with the shaftless hub, and comprising a plurality of fan blades.

5. A shaftless electric fluid-flow device comprising:
a housing;
a shaftless hub, rotatable within the housing, about a central axis, and defining an open central channel that is open along the central axis; and
a fan blade assembly, coupled to the shaftless hub, such that the fan blade assembly co-rotates with the shaftless hub, and comprising a plurality of fan blades.

6. The shaftless electric fluid-flow device of claim 5, wherein:
the open central channel extends along the central axis from a first end of the open central channel to a second end of the open central channel;
the fan blade assembly is fixed to the first end of the open central channel; and
the shaftless electric fluid-flow device further includes a second fan blade assembly, fixed to the second end of the open central channel, such that the second fan blade assembly co-rotates with the shaftless hub, and comprising a plurality of fan blades.

7. The shaftless electric fluid-flow device of claim 5, wherein the fan blade assembly and the second fan blade assembly are located within the open central channel.

8. The shaftless electric fluid-flow device of claim 5, wherein the outer edges of the fan blade assembly and the second fan blade assembly are enclosed within the shaftless hub.

9. The shaftless electric fluid-flow device of claim 5, wherein;
when rotated in a first rotational direction about the central axis, the plurality of fan blades of the fan blade assembly and the second fan blade assembly drive a fluid, outside the housing, through the central axis and the open central channel in a first direction; and
when rotated in a second rotational direction, opposite the first rotational direction, about the central axis, the plurality of fan blades of the fan blade assembly and the second fan blade assembly drive the fluid, outside the housing, through the central axis and the open central channel in a second direction, opposite the first direction.

10. The shaftless electric fluid-flow device of claim 5, the motor core housing comprising:
an inner case disposed between the motor cap and the second motor cap;
a plurality of magnets, disposed around the inner case near the first motor end cap; and
a magnet position sensor disposed between the first motor end cap and the plurality of permanent magnets.

11. The shaftless electric fluid-flow device of claim 10, wherein the plurality of magnets are configured to rotate around the inner case of the shaftless electric fluid-flow device such that the fan blade assembly and second fan blade assembly are rotated relative to the inner lamination stack.

12. The shaftless electric fluid-flow device of claim 10, wherein the magnet position sensor is configured to monitor the position of the permanent magnets.

13. The shaftless electric fluid-flow device of claim 5, further comprising:
a lamination stack assembly, disposed between the fan blade assembly and the second fan blade assembly, wherein the lamination stack assembly is disposed around the plurality of permanent magnets; and
a housing, fixedly connected to the motor cap and the second motor cap, and being disposed around the lamination stack assembly.

14. The shaftless electric fluid-flow device of claim 13, the lamination stack assembly comprising:
a plurality of wire coils, configured to provide a magnetic field for the shaftless electric fluid-flow device;
an outer lamination stack, disposed around the plurality of wire coils and configured to reduce eddy current losses of the shaftless electric fluid-flow device; and
an inner lamination stack, disposed on the inner radius of the plurality of wire coils and configured to reduce eddy current losses of the shaftless electric fluid-flow device.

15. The shaftless electric fluid-flow device of claim 5, further comprising a bearing and a second bearing, which are configured to reduce friction between the first end of the shaftless hub and the motor cap and the second end of the shaftless hub and the second motor cap when the shaftless hub is rotating.

16. The shaftless electric fluid-flow device of claim 5, wherein, when rotating, the fan blade assembly pushes or pulls fluid through the central axis of the open central channel.

17. The shaftless electric fluid-flow device of claim 5, wherein the open central channel is free from obstruction along the central axis of the open central channel.

18. A method of moving fluid through an open central channel, the method comprising steps of:
selecting a direction of fluid flow through the open central channel; and
rotating blades about an axis of rotation of a fan blade assembly or a second fan blade assembly at opposite ends of an unoccupied open channel such that a fluid flows unobstructed through the open central channel and the central channel is coaxial with the axis of rotation of the blades.

19. The method of claim 18, wherein rotation of the blades is driven by electrical power from a power source and rotating the blades of the fan blade assembly and the second fan blade assembly pushes fluid though an open central channel.

20. The method of claim 18, further comprising steps of:
positioning the shaftless electric fluid-flow device into a fluid stream, wherein the step of rotating the blades about the axis of rotation comprises directing the fluid stream over the fan blade assembly, through the shaftless hub, and over the second fan blade assembly such that the fluid stream drives rotation of the fan blade assembly and the second fan blade assembly;
generating electricity via rotation of the blades about the axis of rotation; and
storing the electricity in a battery.
